(19) United States
(12) Patent Application Publication
(10) Pub. No.: US 2014/0183420 A1
(43) Pub. Date: Jul. 3, 2014

(54) SEAMLESS BELT AND PRODUCTION METHOD THEREOF, AND IMAGE FORMING APPARATUS

(71) Applicants: Sumio KAMOI, Tokyo (JP); Yumiko HAYASHI, Kanagawa (JP); Takashi TANAKA, Kanagawa (JP)

(72) Inventors: Sumio KAMOI, Tokyo (JP); Yumiko HAYASHI, Kanagawa (JP); Takashi TANAKA, Kanagawa (JP)

(73) Assignee: RICOH COMPANY, LTD., Tokyo (JP)

(21) Appl. No.: 14/132,501

(22) Filed: Dec. 18, 2013

(30) Foreign Application Priority Data
Dec. 28, 2012 (JP) 2012-287413

(51) Int. Cl. H01B 1/24; C04B 35/00; G03G 15/01

(52) U.S. Cl. CPC G03G 15/14
USPC 252/511; 264/105; 399/302

(57) ABSTRACT

To provide a seamless belt, which includes: a polyether imide containing a siloxane bond; at least one selected from the group consisting of a polyphenylene sulfide, a polyether ether ketone, a thermoplastic fluororesin, and a liquid crystal polymer; an ethylene-glycidyl (meth)acrylate copolymer; and an electrical conductivity-imparting agent.

### BACKGROUND OF THE INVENTION

1. Field of the Invention

The present invention relates to a seamless belt suitable for an intermediate transfer belt, a method for producing a seamless belt, and an image forming apparatus.

2. Description of the Related Art

An intermediate transfer belt used for an electrophotographic image forming apparatus requires uniformity in electric resistance, surface smoothness, mechanical characteristics (high flexure, high elasticity, high ductility), and high size accuracy (film thickness, and peripheral length). Moreover, it is recently required for parts to have flame resistance, and it is necessary to satisfy VTM-0 of flame resistance standard of UL94, which is UL Standard (Under Writers Laboratories Inc. Standard).

As for a material satisfying the aforementioned requirements, a material, in which electrical conductivity is imparted to a thermoset polyimide resin or polyamide imide resin, has been used. As for a method for producing a heat resistant endless belt (seamless belt) using a polyimide resin, for example, disclosed is a method containing cast molding a polyimide vanish on a circumferential surface of a cylinder composed of a metal, followed by heating the cast-molded polyimide varnish to proceed imidization, to thereby form an endless belt of polyimide (see Japanese Patent Application Laid-Open (JP-A) No. 07-295396).

This proposed method however has problems that a material cost is high, and a process of imidization takes a long time, which leads to a so high production cost. Moreover, the proposed method requires a new metal mold every time a size is changed, and therefore a plurality of metal molds need to be prepared to thereby increase an initial cost.

The intermediate transfer belt is an expensive part compared to other parts in an electrophotographic image forming apparatus, and therefore a cost-down of the intermediate transfer belt is desired. The intermediate transfer belt can be produced at an extremely low cost, if it can be produced by extrusion molding or inflation molding using a thermoplastic resin in order to reduce a cost of the intermediate transfer belt.

As for a flame resistant thermoplastic resin, moreover, there are, for example, a fluororesin such as polyvinylidene fluoride (PVDF), a polyacrylate resin, a polyphenylene sulfide (PPS) resin, a polyether sulfone (PES) resin, a polysulfone (PS) resin, a polyether imide (PEI) resin, a polyether ether ketone (PEEK) resin, thermoplastic polyimide (TPI), and a liquid crystal polymer (LCP).

As for an electrically conductive seamless belt using the flame resistant thermoplastic resin, for example, disclosed is an electrically conductive belt containing a polyether sulfone (PES) resin, a liquid crystal polymer (LCP), and electrically conductive filler (see JP-A No. 2006-098602). However, the disclosed belt has low flexibility (MIT test value), and therefore an edge part of the belt tends to be cracked when the belt is running. Therefore the disclosed belt has a problem that it has poor durability.

Moreover, disclosed is an electrically conductive thermoplastic resin film containing polyether imide (PEI), a polyether imide siloxane block copolymer, and electrically conductive carbon (see JP-A No. 2011-26584). The composition of the disclosed film can achieve flame resistance, but cannot achieve desirable mechanical characteristics.

Moreover, disclosed is an electrically conductive endless belt, in which a halogen-based flame retardant is added to a polyamide-based resin (see JP-A No. 2009-145557). The disclosed endless belt however does not achieve the target durability, as the polyamide-based resin has low elasticity. Moreover, water absorption thereof is high, and therefore image failures tend to occur due to dislocation caused by waving of the belt. If a molecular weight of the additive is small, moreover, the additive bleeds out to a surface of the belt, which tends to cause image failures.

Moreover, disclosed is an endless belt-shaped transfer member composed of a polyacrylate resin (see JP-A No. 2000-137389). In accordance with the disclosed technique, however, the flexibility (MIT test value) cannot achieve 500 times or more, which are the target, if about 10% by mass of the electrically conductive filler is added to the polyacrylate resin that is a noncrystalline material.

Moreover, disclosed is a polyphenylene sulfide resin composition containing a polyphenylene sulfide resin, a polyether imide resin or polyether sulfone resin, and a compatibility accelerator having at least one group selected from the group consisting of an epoxy group, an amino group, and an isocyanate group (see Japanese Patent (JP-B) No. 4844559). This literature includes the descriptions that inorganic filler such as carbon black can be added, but only calcium carbonate is used in Examples. Moreover, there is no description that the resin composition is used for an electrically conductive seamless belt. If the disclosed polyphenylene sulfide resin composition is formed into a film having a thickness of 50 μm to 80 μm, moreover, the flame resistance of the film becomes VTM-1 according to UL94, and it is difficult to achieve VTM-0.

Accordingly, there is a need for a seamless belt, which satisfies all of mechanical characteristics, electrical characteristics, and flame resistance required for an intermediate transfer belt of an electrophotographic image forming apparatus, prevents a crack caused at an edge of the belt during running the belt, and does not cause image failures, such as out of color registration.

### SUMMARY OF THE INVENTION

The present invention aims to provide a seamless belt, which satisfies all of mechanical characteristics, electrical characteristics, and flame resistance required for an intermediate transfer belt of an electrophotographic image forming apparatus, can prevent a crack caused at an edge of the belt during running the belt, and does not cause image failures, such as out of color registration.

The present inventors have diligently conducted researches to solve the aforementioned problems. As a result of the researches, the present inventors have come to the insights that a seamless belt, which satisfies all of mechanical characteristics, electrical characteristics, and flame resistance required for an intermediate transfer belt of an electrophotographic image forming apparatus, can prevent crack caused at an edge of the belt during running the belt, and does not cause image failures, such as out of color registration, can be attained by blending electrically conductive filler with a polymer alloy composed of polyether imide having a siloxane bond, which is a noncrystalline resin, at least one crystalline resin selected from the group consisting of a polyphenylene sulfide, a polyether ether ketone, a thermoplastic fluororesin, and a liquid crystal polymer, and an ethylene-glycidyl (meth)acrylate copolymer, which is a compatibility accelerator, because of a synergistic effect thereof.

The present invention is based upon the aforementioned insights of the present inventors, and the means for solving the aforementioned problems are as follows:

The seamless belt of the present invention contains:

a polyether imide containing a siloxane bond;

at least one selected from the group consisting of a polyphenylene sulfide, a polyether ether ketone, a thermoplastic fluororesin, and a liquid crystal polymer;

an ethylene-glycidyl (meth)acrylate copolymer; and

an electrical conductivity-imparting agent.

The present invention can solve the aforementioned various problems in the art, can achieve the aforementioned object, and can provide a seamless belt, which satisfies all of mechanical characteristics, electrical characteristics, and flame resistance required for an intermediate transfer belt of an electrophotographic image forming apparatus, can prevent crack caused at an edge of the belt during running the belt, and does not cause image failures, such as out of color registration.

### BRIEF DESCRIPTION OF THE DRAWINGS

FIG. 1 is a diagram illustrating a relationship between an amount of one polymer among two or more polymers constituting a polymer alloy, and characteristics.

FIG. 2 is a graph depicting a relationship between an amount of polyphenylene sulfide (PPS) relative to silicone-modified polyether imide, and elongation at break.

FIG. 3 is a graph depicting a relationship between an amount of polyphenylene sulfide (PPS) relative to silicone-modified polyether imide, and flexibility (MIT test value).

FIG. 4 is a schematic diagram illustrating a circular die and mandrel used in an extrusion-molding step.

FIG. 5 is a schematic diagram illustrating one example of the image forming apparatus of the present invention.

FIG. 6 is a schematic cross-sectional view illustrating one example of a structure of an image forming unit to which a photoconductor is provided in the image forming apparatus of FIG. 5.

### DETAILED DESCRIPTION OF THE INVENTION

### (Seamless Belt)

The seamless belt of the present invention contains: a polyether imide containing a siloxane bond; at least one selected from the group consisting of a polyphenylene sulfide, a polyether ether ketone, a thermoplastic fluororesin, and a liquid crystal polymer; an ethylene-glycidyl (meth)acrylate copolymer; and an electrical conductivity-imparting agent. The seamless belt of the present invention may further contain other components according to the necessity.

In the present invention, a polyether imide containing a siloxane bond, and at least one crystalline resin selected from the group consisting of a polyphenylene sulfide, a polyether ether ketone, a thermoplastic fluororesin, and a liquid crystal polymer are formed into a polymer alloy with an ethylene-glycidyl (meth)acrylate copolymer serving as a compatibility accelerator.

As for a polymer alloy formed by blending two or more polymers, there are typically a polymer alloy that is in the state where different types of polymers are homogeneously blended without causing phase separation (a compatible polymer alloy), and a polymer alloy that is in the state where different types of polymers are non-compatible and cause phase separation (a non-compatible polymer alloy).

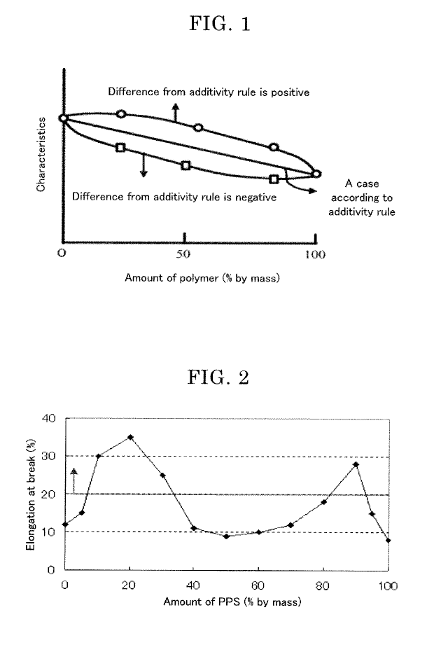

A relationship between an amount of one polymer among two or more polymers in the polymer alloy and characteristics is classified into the following three: (1) a case according to an additivity rule, (2) a case where a difference from the additivity rule is positive, and (3) a case where a difference from the additivity rule is negative, as illustrated in FIG. 1. In case of a non-compatible polymer alloy, it is often the (3) a case where a difference from the additivity rule is negative, and it is difficult to exhibit an effect of the polymer alloy.

The present invention is associated with a polymer alloy composition which has a relationship (2) where the difference from the additivity rule is positive, founded by the present inventors based upon their researched as conducted.

Specifically, a thin film (thickness: 50 μm to 100 μm), formed by forming a polymer alloy of polyether imide (PEI), and at least one crystalline resin selected from the group consisting of polyphenylene is sulfide (PPS), polyether ether ketone(PEEK), a thermoplastic fluororesin (e.g., PVDF), and a liquid crystal polymer (LCP) with an ethylene-glycidyl (meth)acrylate copolymer serving as a compatibility accelerator, had flame resistance of VTM-1 according to UL94 standard, and could not achieve VTM-0, which was a target. As a result of the researches diligently conducted by the present inventors, it has been found that flame resistance of VTM-0 according to UL94 can be achieved by using silicone-modified polyether imide (silicone-modified PEI), which is obtained through block copolymerization of PEI and a siloxane bond, instead of polyether imide (PEI). By using thesilicone-modified PEI instead of PEI, moreover, molding temperature can be lowered to the range of 10° C. to 20° C., and an effect of reducing heat oxidation deterioration (a blister defect) due to retaining during high temperature molding can be attained. Moreover, mechanical characteristics (especially folding resistance) can be improved as a result of the reduction in temperature.

Next, a film formed of a composition, in which 8% by mass of is carbon black is blended to the silicone-modified PEI, has insufficient elongation at break and flexibility (MIT test value) among the mechanical characteristics, as depicted in Table 1 below. Meanwhile, it has been found that compositions containing polyphenylene sulfide (PPS), polyether ether ketone (PEEK), polyvinylidene fluoride (PVDF) as the thermoplastic fluororesin, or a liquid crystal polymer (LCP) cannot achieve the target in any of the items of mechanical characteristics and flame resistance, as depicted in Table 1.

TABLE 1

| | | Composition with carbon black | | | | |
|---|---|---|---|---|---|---|
| | | (Ketjenblack (8% by mass)-formulated product) | | | | |
| | | silicone- | | | | |
| | Target value | modified PEI | PPS | PEEK | PVDF | LCP |
| Tensile | 50 MPa or | A | A | A | A | A |
| strength | greater | | | | | |
| Elongation | 20% or | C | C | C | C | C |
| at break | greater | | | | | |
| Flexibility | 500 times or | C | A | A | A | A |
| (MIT test | more | | | | | |
| value) | | | | | | |
| Tear | 3 N/mm or | A | A | A | A | C |
| strength | greater | | | | | |
| Tensile | 1,800 MPa | A | A | A | A | A |
| elasticity | or greater | | | | | |
| Flame | VTM-0 | A | B | B | B | A |
| resistance | | | | | | |

*In Table 1, A represents that a target has been achieved, C represents that a target has not been achieved, and B represents that there is a dependency to a film thickness and a result of the flame resistance is VTM-1 (provided that, an epoxy-based compatibility accelerator is blended in an amount of 2% by mass) with a thin film thereof (thickness: 50 μm)

Note that, testing methods of the mechanical characteristics and flame resistance are the methods described in Examples explained later.

The present inventors have conducted researched on a polymer alloy using an ethylene-glycidyl (meth)acrylate copolymer as a compatibility accelerator. As a result, they have found that target characteristics can be achieved by a synergistic effect of a polymer alloy containing silicone-modified PEI and at least one crystalline resin selected from the group consisting of a polyphenylene sulfide, a polyether ether ketone, a thermoplastic fluororesin, and a liquid crystal polymer, even though they are polymers each lacking mechanical characteristics or flame resistance.

### <Polyether Imide Containing Siloxane Bond>

The polyether imide containing a siloxane bond is a non-crystalline thermoplastic resin formed by introducing a siloxane group into polyether imide (PEI) to give flexibility exhibited by silicone elastomer, and is a polymer that can be extrusion molded.

The polyether imide (PEI) contains, in a molecule thereof, an imide bond having heat resistant and strength and an ether bond having processability, which are presented by the following general formula 1.

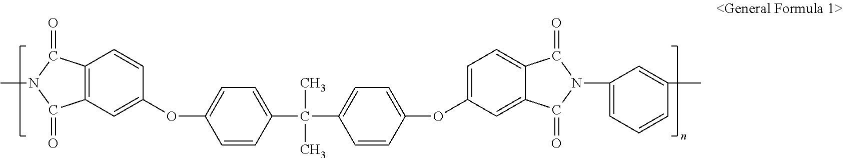

In the general formula 1 above, n represents a polymerization degree, is preferably 60 or greater, more preferably 60 to 200.

The polyether imide containing a siloxane bond is silicone-modified polyether imide obtained through block copolymerization of PEI represented by the general formula 1 with a siloxane group represented by the following general formula 2, and has high flame resistance, desirable extrusion moldability, and excellent flexibility.

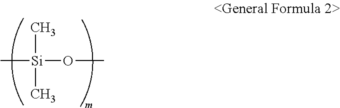

In the general formula 2 above, m represents a polymerization degree, and is preferably 1 or greater, more preferably 1 to 10.

The silicone-modified polyether imide resin may be appropriately synthesized for use, or selected from commercial products. Examples of the commercial product thereof include SILTEM SMT1500, SILTEM SMT1600, and SILTEM SMT-1700, all available from SABIC Innovative Plastics Japan.

### <Polyphenylene Sulfide>

The polyphenylene sulfide (PPS) is a crystalline heat-resistant polymer having a structure represented by the following general formula.

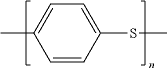

In the general formula above, n represents a polymerization degree, and is preferably 100 or greater, more preferably 100 to 500.

The polyphenylene sulfide (PPS) is roughly classified into two, a crosslinked polymer, and a linear polymer. Among them, in the case where a thin film is produced, as in the present invention, use of the linear polymer is preferable. The crosslinked polymer contains a large amount of a gelation product, which may be appeared as a defect on a surface of a film, as the crosslinked polymer is formed into a film.

When the polyphenylene sulfide (PPS) forms a polymer alloy with the silicone-modified poly-ether imide (silicone-modified PEI), the PPS forms a micro phase separation structure, which gives regions where elongation at break and flexibility (MIT test value) are significantly improved according to an amount of the PPS.

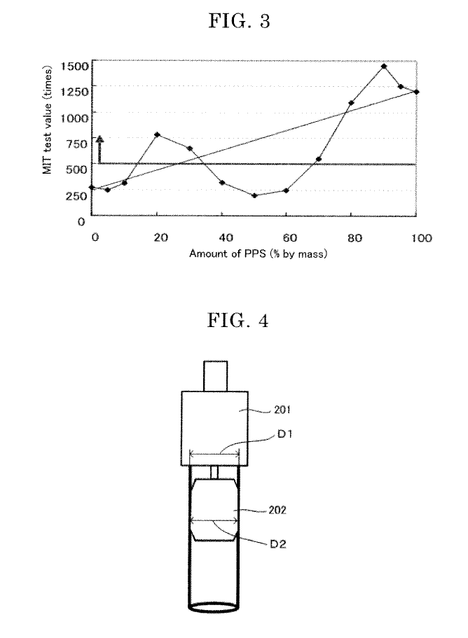

Here, a relationship between an amount of the PPS relative to the silicone-modified PEI and elongation at break is illustrated in FIG. 2. When the amount PPS relative to the silicone-modified PEI is in the region of 5% by mass to 40% by mass and in the region of 70% by mass to 95% by mass, the elongation at break is in the positive position according to the additivity rule, and a synergistic effect is exhibited. Meanwhile, a relationship between an amount of PPS relative to the silicone-modified PEI and flexibility (MIT test value) is illustrated in FIG. 3. When the amount of PPS is in the range of 10% by mass to 40% by mass, and in the range of 60% by mass to 95% by mass, the flexibility (MIT test value) is in the positive position according to the additivity rule, and a synergistic effect is exhibited. As described above, elongation at break and flexibility (MIT test value), which are especially important for a seamless belt for electrophotography are significantly improved by blending the PPS with the silicone-modified PEI.

The polyphenylene sulfide (PPS) may be appropriately synthesized for use, or elected from commercial products. Examples of the commercial product thereof include E1380 (linear PPS, manufactured by Toray Industries Inc.), PY-23 (linear high molecular weight PPS, manufactured by Toray Industries Inc.), and T1881-3 (linear high molecular weight PPS, manufactured by Toray Industries Inc.).

### <Polyether Ether Ketone>

The polyether ether ketone (PEEK) is a crystalline heat-resistant polymer having a structure represented by the following general formula.

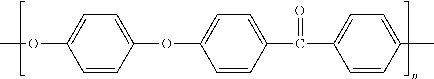

In the general formula above, n represents a polymerization degree, and is preferably 100 or greater, more preferably 100 to 1,000.

The polyether ether ketone (PEEK) is appropriately selected depending on the intended purpose without any limitation, but it may be a modified product with another material.

Similarly to the PPS, a polymer alloy of the silicone-modified PEI with the PEEK can significantly prove flexibility (MIT test value). As PEEK alone has high tensile strength and tensile elasticity, moreover, a polymer alloy of PEEK also has high tensile strength and tensile elasticity. However, PEEK is an expensive material compared to other materials. Therefore, an amount of the PEEK is preferably 30% by mass or less.

The polyether ether ketone may be appropriately synthesized for use, or selected from commercial products. Examples of the commercial product thereof include 5000G (manufactured by Daicel-Evonik Ltd.).

### <Thermoplastic Fluororesin>

The thermoplastic fluororesin is appropriately selected depending on the intended purpose without any limitation, and examples thereof include polyvinylidene fluoride (PVDF), a polyethylene-tetrafluoroethylene resin (ETFE), a vinylidene fluoride-ethylene tetrafluoride copolymer resin (PVDF-ETFE), polychlorotrifluoroethylene (PCTFE), a tetrafluoroethylene-hexafluoropropylene copolymer (FEP), and a tetrafluoroethylene-perfluoroalkyl vinyl ether copolymer (PFA). These may be used alone, or in combination. Among them, polyvinylidene fluoride (PVDF) is particularly preferable in view of its flame resistance.

The polyvinylidene fluoride (PVDF) is a heat resistant polymer represented by the following general formula.

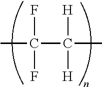

In the general formula above, n represents a polymerization degree, and is preferably 2,000 or greater, more preferably 2,000 to 10,000.

The polyvinylidene fluoride (PVDF) may be appropriately synthesized for use, or selected from commercial products. Examples of the commercial product thereof include KYMR741 (manufactured by Arkema K.K.).

### <Liquid Crystal Polymer>

The liquid crystal polymer (LCP) is appropriately selected depending on the intended purpose without any limitation, but it is preferably polyester resins having aromatic rings, which are represented by the following general formulae and classified into Type 1 to Type 3 based on heat resistance.

[Type 1] Deflection temperature under load being 300° C. or higher

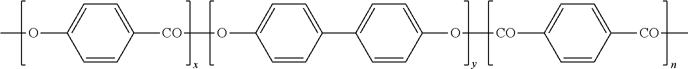

[Type 2] Deflection temperature under load being 240° C. or higher

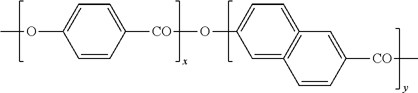

[Type 3] Deflection temperature under load being 200° C. or lower

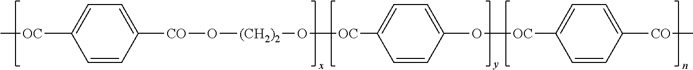

In the general formulae above, x, y, and n each represent a copolymerization ratio of each structural unit.

The liquid crystal polymer (LCP) exhibits crystallinity in a melted state, and its oriented state is maintained when it is solidified. Therefore, the LCP is strongly orientated in a flow direction (extruding direction), and exhibits a strong anisotropy. When the LCP is formed into a film, the tear strength along the orientation direction (extruding direction) becomes extremely weak. In the case where the silicone-modified PEI and the LCP are formed into a polymer alloy, therefore, an amount of the LCP is preferably 0.5% by mass to 30% by mass, more preferably 1% by mass to 10% by mass.

The liquid crystal polymer may be appropriately synthesized for use, or selected from commercial products. Examples of the commercial product thereof include RB110 (manufactured by Sumitomo Chemical Co., Ltd.).

A mass ratio (A/B) of the polyether imide containing a siloxane bond (A) to at least one selected from the group consisting of the polyphenylene sulfide, the polyether ether ketone, the thermoplastic fluororesin, and the liquid crystal polymer (B) is appropriately selected depending on the intended purpose without any limitation, but it is preferably 90/10 to 10/90, more preferably 90/10 to 70/30, or 10/90 to 30/70. When the mass ratio is close to an equivalent formulation, a domain size of a phase separation structure becomes large, and therefore mechanical characteristics may be deteriorated. When a ratio of A in the mass ratio (A/B) is greater than 90% by mass, an amount of the so crystalline resin is reduced, and therefore mechanical characteristics (especially folding resistance) may be deteriorated. When a ratio of A in the mass ratio (A/B) is less than 10% by mass, moldability may be deteriorated so that dents, scratches, or kinks tend to be formed. When mass ratio (A/B) is in the aforementioned more preferable range, it is so preferable, as all of mechanical characteristics, electrical characteristics, flame resistance, which are required for an intermediate transfer belt of an electrophotographic image forming apparatus, are satisfied, cracks caused at an edge of a belt during running of the belt is prevented, and image failures, such as out of color registration, are not formed.

### <Ethylene-Glycidyl (Meth)Acrylate Copolymer>

The ethylene-glycidyl (meth)acrylate copolymer contains, in a molecule thereof, a glycidyl group and an ethylene chain, and is used as a compatibility accelerator.

The ethylene-glycidyl (meth)acrylate copolymer may be appropriately synthesized for use, or selected from commercial products. Examples of the commercial product thereof include Bondfast E, and Bondfast 2C (both manufactured by Sumitomo Chemical Co., Ltd.).

A synthesis method of the ethylene-glycidyl (meth)acrylate copolymer is appropriately selected depending on the intended purpose without any limitation, and examples thereof include a method containing reacting ethylene and glycidyl methacrylate in a vapor phase at high temperature and high pressure to synthesize an ethylene-glycidyl methacrylate copolymer.

An amount of the ethylene-glycidyl (meth)acrylate copolymer is appropriately selected depending on the intended purpose without any limitation, but it is preferably 0.5% by mass to 5% by mass, more preferably 1% by mass to 2% by mass. When the amount thereof is less than 0.5% by mass, mechanical characteristics of a resulting seamless belt may be impaired. When the amount thereof is greater than 5% by mass, surface glossiness of a resulting seamless belt may be low.

### <Electrical Conductivity-Imparting Agent>

The electrical conductivity-imparting agent is appropriately selected depending on the intended purpose without any limitation, and examples thereof include a carbon-based electrical conductivity-imparting agent, a metal-based electrical conductivity-imparting agent, a metal oxide-based electrical conductivity-imparting agent, and a metal coating-based electrical conductivity-imparting agent.

Examples of the metal-based electrical conductivity-imparting agent include Ag, Ni, Cu, Zn, Al, and stainless steel.

Examples of the metal oxide-based electrical conductivity-imparting agent include zinc oxide, tin oxide, titanium oxide, and indium oxide.

Among them, carbon black, a combination of carbon black and a polymeric electrically conductive agent, and carbon nanotubes are particularly preferable, as they are inexpensive, and can control the electric resistance to the middle to high range.

### —Carbon Black—

The carbon black is appropriately selected depending on the intended purpose without any limitation, and examples thereof include; electrically conductive carbon black, such as Ketjenblack, acetylene black, and oil furnace black; carbon for rubber, such as SAF, ISAF, HAF, FEF, GPF, SRF, FT, and MT; carbon for color inks, which has been subjected to an oxidation treatment; thermal decomposition carbon; natural graphite; and synthetic graphite. Among them, electrically conductive carbon black is preferable, and Ketjenblack is particularly preferable. As the Ketjenblack has a large number of particles per unit weight, a desirable ohmic value can be achieved with a small amount of the Ketjenblack, and degradation of mechanical characteristics can be kept minimum.

The carbon black can be selected from commercial products, and examples of the commercial product thereof include DENKA BLACK (manufactured by DENKI KAGAKU KOGYO KABUSHIKI KAISHA), and Ketjenblack EC300J (manufactured by Lion Corporation).

### —Combination of Carbon Black and Polymeric Electrically Conductive Agent—

When a large amount of the electrical conductivity-imparting agent is blended, mechanical characteristics of a resulting seamless belt is degraded. Therefore, an amount of the electrical conductivity-imparting agent is appropriately selected depending on the intended purpose without any limitation, but it is preferably 10% by mass or less. However, an amount of the carbon black exceeds 10% by mass depending on a combination of a polymer material and the carbon black. Therefore, it has been found that deterioration of mechanical characteristics due to an increased amount of carbon black can be prevented by using the carbon black and a polymeric electrically conductive agent in combination.

The polymeric electrically conductive agent is appropriately selected depending on the intended purpose without any limitation, for example, various polymeric materials having ion conductivity can be used as the polymeric electrically conductive agent. Among them, polyether ester amide is preferable, because it has an excellent effect of imparting an excellent electrical conductivity to a seamless belt.

The polyether ester amide means a compound, for example, containing a copolymer composed of a polyamide block unit (e.g., Nylon 6, Nylon 66, Nylon 11, and Nylon 12) and a polyether ester unit, as a main component.

The polyether ester amide may be appropriately synthesized for use, or selected from commercial products. Examples of the commercial product thereof include PELESTAT series, and PELECTRON series, both manufactured by Sanyo Chemical Industries, Ltd.

A synthesis method of the polyether ester amide is appropriately selected depending on the intended purpose without any limitation, and examples thereof include a conventional polymerization method, such as melt polymerization.

When the polymeric electrically conductive agent is mixed in a resin and the mixture is heated and mixed, the polymeric electrically conductive agent is elongated at the time of molding to thereby form strip-shaped electrically conductive circuits therein. However, use of the polymeric electrically conductive agent is not suitable for matching a desirable electric resistivity, and it is difficult to finely control the electric resistivity with the polymeric electrically conductive agent. Therefore, use of carbon black in combination with the polymeric electrically conductive agent can reduce an amount of the electrical conductivity-imparting agent for use, and can be controlled to attain a desirable electric resistivity. An amount of the carbon black is appropriately selected depending on the intended purpose without any limitation, but it is preferably 1% by mass to 5% by mass. An amount of the polymeric electrically conductive agent is appropriately selected depending on the intended purpose without any limitation, but it is preferably 1% by mass to 3% by mass,

### —Carbon Nanotubes—

Shapes, structures, and sizes of the carbon nanotubes are appropriately selected depending on the intended purpose without any limitation.

The carbon nanotubes may be single-walled carbon nanotubes (SWNT), or multi-walled carbon nanotubes (MWNT).

The single-walled carbon nanotubes (SWNT) are appropriately selected depending on the intended purpose without any limitation, but they are preferably single-walled carbon nanotubes (SWNT) each having a diameter of about 10 nm to about 200 nm, and length of about 0.5 μm to 10 μm.

The single-walled carbon nanotubes are preferably selected from armchair carbon nanotubes, zigzag carbon nanotubes or chiral carbon nanotubes.

The multi-walled carbon nanotubes (MWNT) are appropriately selected depending on the intended purpose without any limitation, but they are preferably multi-walled carbon nanotubes (MWNT) each having a diameter of about 10 nm to about 200 nm, and length of about 0.5 μm to about 10 μm, and a number of walls of which is about 2 to about 100.

Among the carbon nanotubes, the carbon nanotubes having a large aspect ratio can give electrical conductivity with a small amount thereof, and has excellent dispersibility.

The volume resistivity of 10⁸ Ω·cm to 10¹¹ Ω·cm can be achieved when the carbon nanotube each having a diameter of 10 nm to 200 nm, and a length of 0.5 μm to 10 μm are used in an amount of 1% by mass to 3% by mass, and therefore, the amount thereof for use can be reduced compared to a case of the carbon black, and excellent mechanical characteristics can be achieved.

### <Other Components>

Other components are appropriately selected depending on the intended purpose without any limitation, and examples thereof include a lubricant, an electric resistance controlling agent, an antioxidant, a reinforcing agent, fillers, a vulcanization accelerator, an extending agent, various pigments, a UV absorber, an antistatic agent, a dispersing agent, and a neutralizer.

The seamless belt of the present invention can be formed by melt-kneading a polyether imide containing a siloxane bond, at least one selected from the group consisting of a polyphenylene sulfide, a polyether ether ketone, a thermoplastic fluororesin, and a liquid crystal polymer, a ethylene-glycidyl(meth)acrylate copolymer, and an electrical conductivity-imparting agent to obtain a melt-kneaded product, and molding the melt-kneaded product through melt-extrusion molding, injection molding, blow molding, or inflation molding, but the seamless belt of the present invention can be preferably produced by the method of producing a seamless belt of the present invention, which is explained below.

### (Method for Producing Seamless Belt)

The method for producing a seamless belt of the present invention contains a melt-kneading step, and an extrusion-molding step, and may further contain other steps.

### <Melt-Kneading Step>

The melt-kneading step is melt-kneading a polyether imide containing a siloxane bond, at least one selected from the group consisting of a polyphenylene sulfide, a polyether ether ketone, a thermoplastic fluororesin, and a liquid crystal polymer, an ethylene-glycidyl (meth)acrylate copolymer, and electrical conductivity-imparting agent, to thereby obtain a melt-kneaded product.

As for the polyether imide containing a siloxane bond, the at least one selected from the group consisting of the polyphenylene sulfide, the polyether ether ketone, the thermoplastic fluororesin, and the liquid crystal polymer, the ethylene-glycidyl (meth)acrylate copolymer, and the electrical conductivity-imparting agent, those mentioned above can be used.

The melt-kneading is appropriately selected depending on the intended purpose without any limitation, but the melt-kneading can be performed by a kneader, such as a single screw extruder, a twin screw extruder, Banbury mixer, a roll kneader, and a kneader.

### <Extrusion-Molding Step>

The extrusion-molding step is extrusion-molding the melt-kneaded product.

In the extrusion-molding step, it is preferred that a mandrel be provided at a bottom of a circular die with respect to an extruding direction, and be linked with circular die, and the extrusion-molded product extruded from the circular die be cooled by the mandrel to temperature equal to or lower than glass transition temperature of the melt-kneaded product. When the cooling temperature is higher than the glass transition temperature of the melt-kneaded product, the peripheral length of the seamless belt becomes smaller than the diameter of the mandrel, and therefore a desirable peripheral length of the seamless belt may not be obtained.

As illustrated in FIG. 4, a mandrel 202 is provided at a bottom of a circular die (spiral die) 201 with respect to an extruding direction, and is linked with the die. The mandrel 202 is connected to an oil temperature controller (not illustrated), and the temperature of the mandrel 202 can be controlled. As the mandrel temperature is set to temperature equal to or lower than glass transition temperature of the melt-kneaded product (alloyed polymers), a tube-shaped extrusion molded-product is cooled and solidified until it is taken out from the mandrel, to thereby obtain a seamless belt having the same size (peripheral length) to the mandrel diameter D2. When the mandrel temperature is higher than the glass transition temperature of the melt-kneaded product, on the other hand, the size (peripheral length) of the seamless belt becomes smaller than the mandrel diameter D2 due to tension caused by pulling the seamless belt from the mandrel, and therefore the size is not stabilized. In this case, the ratio (D1:D2) of the die lip diameter D1 to the mandrel diameter D2 is preferably 1:1, but a variation within ±about 10% is acceptable.

### <Other Steps>

Other steps are appropriately selected depending on the intended purpose without any limitation, and examples thereof include a cutting step, a washing step, and a drying step.

The average thickness of the seamless belt of the present invention is appropriately selected depending on the intended purpose without any limitation, but it is preferably 30 μm to 200 μm, more preferably 50 μm to 150 μm. When the average thickness thereof is less than 30 μm, strength of the seamless belt is small and the seamless belt tends to be torn. When the average thickness thereof is more than 200 μm, flexibility is impaired to thereby lower running ability of the seamless belt, and also the seamless belt tends to be split.

As for a measuring method of the average thickness of the seamless belt, for example, the average thickness thereof can be measured by a contact type (pointer type) or eddy current type thickness tester, e.g., an electronic micrometer (manufactured by Anritsu Corporation).

The seamless belt of the present invention satisfies the following mechanical characteristics, electrical characteristics, and flame resistance, which are required for an intermediate transfer belt of an electrophotographic image forming apparatus.

### (1) Mechanical Characteristics

The tensile strength (tensile stress at break) of the seamless belt is appropriately selected depending on the intended purpose without any limitation, but it is preferably 50 MPa or greater, more preferably 50 MPa to 300 MPa. When the tensile strength (tensile stress at break) is less than 50 MPa, there are problems that the seamless belt ay be torn, or cracked.

The tensile strength can be measured, for example, in accordance with JIS K7127.

The tensile elasticity of the seamless belt is appropriately selected depending on the intended purpose without any limitation, but it is preferably 1,800 MPa or greater, more preferably 1,800 MPa to 5,000 MPa. When the tensile elasticity less than 1,800 MPa, the durability of the seamless belt is insufficient so that scratches may be formed on a to surface of the seamless belt over time, to thereby cause age failures.

The tensile elasticity can be measured, for example, in accordance with JIS K7127.

The elongation at break of the seamless belt is appropriately selected depending on the intended purpose without any limitation, but it is preferably 20% or greater, more preferably 20% to 300%. When the elongation at break is less than 20%, scratches or dents tend to be formed on the seamless belt.

The elongation at break can be measured, for example, in accordance with JIS K7127.

The flexibility (0.38R-MIT test value) of the seamless belt is appropriately selected depending on the intended purpose without any limitation, but it is preferably 500 times or greater. The flexibility is preferably larger, and the upper limit is not particularly restricted. Note that, the thickness of the seamless belt is 70 μm±10 μm. When the flexibility (MIT test value) is less than 500, the durability of the seamless belt is impaired, and therefore such seamless belt may not be employed in a type of a device which requires durability.

The flexibility (MIT test value) can be measured, for example, in accordance with JIS P8115.

The tear strength of the seamless belt is appropriately selected depending on the intended purpose without any limitation, but it is preferably 3 N/mm or greater. The tear strength is preferably greater, and the upper limit thereof is not particularly restricted. When the tear strength is less than 3 N/mm, the durability of the seamless belt is impaired, and therefore cracks tend to be formed at an edge of the belt.

The tear strength can be measured, for example, in accordance with JIS K7128.

### (2) Electrical Characteristics

The surface resistivity of the seamless belt is appropriately selected depending on the intended purpose without any limitation, but it is preferably 1×10⁸Ω/□ to 1×10¹¹Ω/□ (with proviso that it is between 10 V to 500 V).

The volume resistivity of the seamless belt is appropriately selected depending on the intended purpose without any limitation, but it is preferably 1×10⁸ Ω·cm to 1×10¹¹ Ω·cm (with proviso that it is between 10 V to 500 V).

The resistivity can be measured, for example, by means of HIRESTA UP MCP-HT450 (manufactured by Mitsubishi Chemical Analytech Co., Ltd.) at the temperature of 20° C.±3° C., and the relative humidity of 50%+10%.

As for the volume resistivity (Ω·cm) the value after applying 100 V for 10 sec is measured. As for the surface resistivity (Ω/□), the value after applying 100 V for 10 sec, and the value after applying 500 V for 10 sec are measured. The average of the values measured at the 5 points is determined as the measured value.

### (3) Flame Resistance

The flame resistance of the seamless belt is appropriately selected depending on the intended purpose without any limitation, but it is preferably VTM-0 based on the judging standards of UL94 vertical flame test (UL94VTM).

The seamless belt of the present invention is suitably used for various applications, but is suitably used for an intermediate transfer belt of an image forming apparatus, which is explained below, as the seamless belt satisfies all of the mechanical characteristics, electrical characteristics, and flame resistance, which are required for an intermediate transfer belt of an electrophotographic image forming apparatus, can prevent cracks formed at the belt edge during running of the belt, and does not cause image failure, such as out of color registration.

### (Image Forming Apparatus)

A first embodiment of the image forming apparatus of the present invention contains an image bearing member, an electrostatic latent image forming unit configured to form an electrostatic latent image on the image bearing member, a developing unit configured to develop the electrostatic latent image formed on the image bearing member with a toner to form a toner image, a primary transferring unit configured to transfer the toner image on the image bearing member onto an intermediate transfer belt, a secondary transferring unit configured to transfer the toner image on the intermediate transfer belt onto a recording medium, and a fixing unit configured to fix the toner image on the recording medium. The first embodiment of the image forming apparatus may further contain other units according to the necessity.

The intermediate transfer belt is the seamless belt of the present invention.

A second embodiment of the image forming apparatus of the present invention contains an image bearing member, an electrostatic latent image forming unit configured to form an electrostatic latent image on the image bearing member, a developing unit configured to develop the electrostatic latent image formed on the image bearing member with a toner to form a toner image, a transfer belt configured to convey a recording medium, onto which the toner image on the image hearing member is transferred, a transferring unit configured to transfer the toner image on the image bearing member onto the recording medium, and a fixing unit configured to fix the toner image on the recording medium. The second embodiment of the image forming apparatus may further contain other units according to the necessity.

The transfer belt is the seamless belt of the present invention.

FIG. 5 is a schematic diagram illustrating one example of the image forming apparatus of the present invention. The image forming apparatus of FIG. 5 is configured to form a color image with 4 colors, yellow (depicted as “Y” hereinafter), cyan (depicted as “C” hereinafter), magenta (depicted as “M” hereinafter), and black (depicted as “K” hereinafter), of toners.

First, a basic structure of an image forming apparatus (so-called a “tandem image forming apparatus”), which is equipped with a plurality of image bearing members aligned parallel along the traveling direction of a surface traveling member, is explained.

The image forming apparatus illustrated in FIG. 5 is equipped with four photoconductors 1Y, 1C, 1M, 1K, as image bearing members. Note that, a drum-shaped photoconductor is explained as an example here, but a belt-shaped photoconductor can be also used. Each of the photoconductors 1Y, 1C, 1M. 1K is driven to rotate in the direction represented with an arrow in FIG. 5, with being contact with an intermediate transfer belt 10, which is a surface traveling member. Each of the photoconductors 1Y, 1C, 1M, 1K contains a photoconductive layer formed on a relatively thin cylindrical electrically conductive base, and a protective layer formed on the photoconductive layer. An intermediate layer may be provided the photoconductive layer and the protective layer,

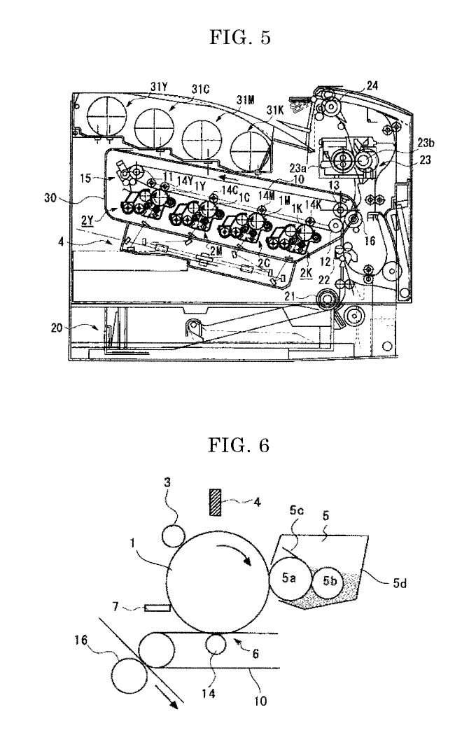

FIG. 6 is a schematic cross-sectional view illustrating an example of a structure of an image forming unit 2 provided to the photoconductor of FIG. 5. Note that, the structure of the surroundings of each of the photoconductors 1Y, 1C, 1M, 1K in the respective image forming unit 2Y, 2C, 2M, 2K is identical. Therefore, only one image forming unit is illustrated in the drawing, and the references for distinguishing the colors Y, C, M, and K are omitted. In the surrounding area of the photoconductor 1, a charging unit 3 as a charging unit, a developing unit 5, a transferring unit 6 configured to transfer a toner image formed on the photoconductor 1 onto a recording medium or an intermediate transfer belt 10, and a cleaning unit 7 configured to remove the toner remained on the photoconductor 1 without being transferred are provided in this order along the surface traveling direction of the photoconductor 1. A space is secured between the charging unit 3 and the developing unit 5 so that light emitted from an exposing unit 4, which is configured to expose the charged surface of the photoconductor 1 to light based on the image data to write an electrostatic latent image, can be passed through to the photoconductor 1.

The charging unit 3 is configured to negatively charge a surface of the photoconductor 1. The charging unit 3 is equipped with a charging roller, serving as a charging member configured to perform a charging process in a so-called contact or proximity charging system. Specifically, the charging unit 3 brings the charging roller into a contact with or in proximity of a surface of the photoconductor 1, and applies negative bias to the charging roller to thereby charge the surface of the photoconductor 1. The direct current charging bias that make the surface potential to the photoconductor 1 −500 V is applied to the charging roller.

Note that, the bias where direct current bias and alternating current bias are superimposed can be also used as charging bias. Moreover, a cleaning brush configured to clean a surface of the charging roller may be provided to the charging unit 3. Note that, as for the charging unit 3, thin films may be wound around at the both edges on the peripheral surface of the charging roller with respect to the axial direction thereof, and such charging roller may be provided to be in contact with a surface of the photoconductor 1. With this structure, a surface of the charging roller and a surface of the photoconductor 1 are only apart by a thickness of the film, and hence they are extremely close to each other. Accordingly, the charging bias applied by the charging roller generates electric discharge between the surface of the charging roller and the surface of the photoconductor, and this electric discharge charges the surface of the photoconductor.

To the surface of the photoconductor 1, which has been charged in the aforementioned manner, is exposed to light by the exposing unit 4, to thereby form an electrostatic latent image corresponding to each color. The exposing unit 4 is configured to write an electrostatic latent image corresponding to each color onto the photoconductor 1 based on image information corresponding to each color. Note that, the exposing unit 4 employs a laser system, but can also employ another system using an LED array and an imaging unit.

A toner supplied from a toner bottle 31Y, 31C, 31M, 31K into a developing unit 5 is transported by a developer supplying roller b, and then is borne on a developing roller 5a. The developing roller 5a is transported into a developing region facing the photoconductor 1. A surface of the developing roller 5a moves with the faster linear speed than the surface of the photoconductor 1 in the same direction in the region facing the photoconductor 1 (may be referred to as a “developing region” hereinafter). The toner of the developing roller 5a is rubbed on the surface of the photoconductor 1 to supply the toner onto the photoconductor 1. In this process, developing bias of −300 V is applied to the developing roller 5a from a power source (not illustrated) to thereby form a developing electric field in the developing region. Between the electrostatic latent image on the photoconductor 1 and the developing roller 5a, an electrostatic force towards the side of the electrostatic latent image acts on the toner on the developing roller 5a. As a result, the toner on the developing roller 5a is deposited on the electrostatic latent image formed on the photoconductor 1. As a result of the deposition of the toner, the electrostatic latent image on the photoconductor 1 is developed to a toner image corresponding to each color.

The intermediate transfer belt 10 of the transferring unit 6 is supported by three supporting rollers 11, 12, 13, and has a structure where it is endlessly rotated in the direction with the arrow shown in FIG. 5. The toner images on the photoconductors 1Y, 1C, 1M, 1K are transferred onto the intermediate transfer belt 10 by an electrostatic transfer system so that the toner images are superimposed to each other. The electrostatic transfer system may also have a structure where a transfer charger is used, but in the present embodiment, the structure where a transfer roller 14, which generates less transfer dust particles, is used. Specifically, primary transfer rollers 14Y, 14C, 14M, 14K serving as transferring units 6 are respectively provided at the back surface of the intermediate transfer belt 10 which are in contact with the photoconductors 1Y, 1C, 1M, 1K. Here, a primary transfer nip is formed with a part of the intermediate transfer belt 10, which is pressed by each of the primary transfer rollers 14Y, 14C, 14M, 14K, and each of the photoconductors 1Y, 1C, 1M, 1K. When the toner image on each of the photoconductors 1Y, 1C, 1M, 1K is transferred to the intermediate transfer belt 10, positive bias is applied to each primary transfer roller 14. As a result, a transfer electric field is formed in each primary transfer nip, and the toner image on each of the photoconductors 1Y, 1C, 1M, 1K is so electrostatically deposited and transferred onto the intermediate transfer belt 10.

In the case where the toner image formed on the photoconductor 1 is transferred to the intermediate transfer belt 10, the photoconductor 1 and the intermediate transfer belt 10 are preferably brought into contact with each other with pressure. The pressure for this is preferably in the range of 10 N/m to 60 N/m.

In the surrounding area of the intermediate transfer belt 10, a belt cleaning unit 15 configured to remove the toner remained on the surface of the intermediate transfer belt is provided. The belt cleaning unit 15 has a structure where the unnecessary toner deposited on the surface of the intermediate transfer belt 10 is collected by a fur brush and a cleaning blade. Note that, the collected unnecessary toner is transported from the belt cleaning unit 15 to a toner waste tank (not illustrated) by a conveying unit (not illustrated). Moreover, a secondary transfer roller 16 is provided in contact with an area of the intermediate transfer belt 10 supported by the supporting roller 13. A secondary transfer nip is formed between the intermediate transfer belt 10 and the secondary transfer roller 16, and a transfer sheet serving as a recording medium fed into the secondary transfer nip with a certain timing. The transfer sheet is stored in a paper feeding cassette 20 provided at the bottom side of the exposing unit 4 in the drawing, and the transfer sheet is conveyed to the secondary transfer nip by a paper feeding roller 21, a couple of registration rollers 22, etc. The toner images superimposed on the intermediate transfer belt 10 are collectively transferred on the transfer sheet in the secondary transfer nip. At the time of the secondary transferring, positive bias is applied to the secondary transfer roller 16 to form a transfer electric field, and the toner images on the intermediate transfer belt 10 are transferred onto the transfer sheet by the transfer electric field.

Downstream of the transfer sheet conveying direction of the secondary transfer nip, a heat fixing device 23 serving as a fixing unit is provided. The heat fixing device 23 is equipped with a heating roller 23a inside which a heater is mounted, and a pressure roller 23b configured to apply pressure. The transfer sheet passed through the secondary transfer nip is nipped between these rollers to receive heat and pressure. As a result, the toner on the transfer sheet is melted, and the toner images are fixed on the transfer sheet. The transfer sheet after fixing is discharged on a discharge tray on the top face of the device by a paper discharging roller 24.

The developing unit 5 is designed so that part of the developing roller 5a serving as a developer bearing member is exposed from an opening of a casing of the developing unit 5. In this embodiment, a one-component developer without containing carrier is used. The so developing unit 5 stores therein a toner of corresponding color supplied from the respective toner bottle 31Y, 31C, 31M, 31K illustrated in FIG. 5. These toner bottles 31Y, 31C, 31M, 31K are each independently detachably mounted in a main body of the image forming apparatus so that each bottle can be independently replaced. Owing to such configuration, only the toner bottle 31Y, 31C, 31M, 31K can be replaced at the time when all the toner is spent. Namely, other constitutional members, which does not reach the ends of their service life at the time when all the toner is spent, can be still used, and therefore the cost for users can be suppressed.

The developer (toner) in the developer storage container 5d is transported to a nip of the developing roller 5a, which is a developer bearing member configured to bear, on the surface thereof, the developer to be supplied to the photoconductor 1, with being stirred by a supply roller 5b. During this process, the supply roller 5b and the developing roller 5a are rotated in opposite directions (counter directions) in the nip. Moreover, an amount of the toner on the developing roller 5a is regulated with a regulating blade c, which is serving as a developer layer regulating member, and is provided to be in contact with the developing roller 5a, to thereby form a thin toner layer on the developing roller 5a. Moreover, the toner is rubbed at the nip between the supply roller 5b and the developing roller 5a, and the area between the regulating blade 5c and is the developing roller 5a so that the charging amount thereof is controlled to an appropriate amount.

In the image forming apparatus, a plurality of constitutional elements, such as a latent image bearing member, a charging unit, and a developing unit may be integrated to compose a process cartridge. The process cartridge can be detachably mounted in a main body of the image forming apparatus, such as a photocopier, and a printer.

### EXAMPLES

Examples of the present invention are explained hereinafter, but Examples shall not be construed to as limit the scope of the present invention.

### Example 1

### Production of Seamless Belt

Eighty parts by mass of silicone-modified polyether imide (silicone-modified PEI) (SILTEM SMT-1700, manufactured by SABIC Innovative Plastics Japan), 20 parts by mass of polyphenylene sulfide (PPS) (E1380, linear PPS, manufactured by Toray Industries Inc.), 1 part by mass of an ethylene-glycidyl methacrylate copolymer (Bondfast E, manufactured by Sumitomo Chemical Co., Ltd.) serving as a compatibility accelerator, and 4.5 parts by mass of carbon black (Ketjenblack EC300J, manufactured by Lion Corporation) serving as an electrical conductivity-imparting agent were melt-kneaded at 320° C.±10° C. by means of a twin screw extruder (L/D=−60), to thereby form the materials into a pellet. The obtained pellet (melt-kneaded product) had glass transition temperature of 196° C. The glass transition temperature of the melt-kneaded product was measured by DSC.

Next, the pellet was placed into a hopper unit of an extrusion molding device equipped with a circular die illustrated in FIG. 4. The pellet was extrusion-molded into a melt tube in the direction below the circular die at the molding temperature of 320° C., and the mandrel temperature of 185° C. The extrusion-molded product was sliced, to thereby produce a seamless belt of Example 1, having an inner diameter of 250 mm, a width of 240 mm, and a thickness of 72 μm.

### Examples 2 to 22 and Comparative Examples 1 to 8

### Production of Seamless Belt

Seamless belts of Examples 2 to 22 and Comparative Examples 1 to 8 were each produced in the same manner as in Example 1, provided that materials depicted in Table 2 were used, and extrusion molding was performed at the molding temperature and mandrel temperature as depicted in Table 2 to give the molding thickness as depicted in Table 2. Note that, in Table 2, an amount of each component was based on “part(s) by mass.” Note that, the glass transition temperature of the melt-kneaded product was measured by DSC.

Various properties of the seamless belts produced in Examples and Comparative Examples were evaluated in the following manners. The results are presented in Table 2.

### <Evaluation of Mechanical Characteristics>

(1) The tensile strength (tensile stress at break) was measured by means of Autograph AGS-5kNX (manufactured by Shimadzu Corporation) in accordance with JIS K7127. The target value was 50 MPa or greater.
(2) The tensile elasticity was measured by means of Autograph AGS-5kNX (manufactured by Shimadzu Corporation) in accordance with JIS K7127. The target value was 1,800 MPa or greater.
(3) The elongation at break was measured by means of Autograph AGS-5kNX (manufactured by Shimadzu Corporation) in accordance with JIS K7127. The target value was 20% or greater.
(4) The flexibility (0.38R-MIT test value) was measured by means of MIT-DA (manufactured by Toyo Seiki Co., Ltd.) in accordance with JIS P8115. The target value was 500 times or more.
(5) The tear strength was measured by means of Autograph AGS-5 kNX (manufactured by Shimadzu Corporation) in accordance with JIS K7128.
The target value was 3 N/mm or greater.

### <Evaluation of Flame Resistance>

A combustion test was performed based on a method of a vertical flame test specified in Safety Standard UL94 of Underwriters Laboratories, with n=5 (number of samples was 5). The result was judged as VTM-0, VTM-1, VTM-2, or Not based on the judging standards of the UL94 vertical flame test (UL94VTM). The result of VTM-0 was regarded as acceptable.

As for a sample, a test piece having a length of 200 mm, a width of 50 mm, and a thickness of 0.06 mm was used.

### <Measurement of Resistivity>

Each of the produced seamless belts was subjected to the measurement of resistivity by means of HIRESTA UP MCP-HT450 (manufactured by Mitsubishi Chemical Analytech Co., Ltd.) at temperature of 20° C.±3° C., relative humidity of 50%±10%.

As for the volume resistivity (Ω·cm), the value just after applying 100 V for 10 sec was measured. As for the surface resistivity (Ω/□), the value just after applying 100 V for 10 sec and the value just after applying 500 V for 10 sec were measured. The average of the values obtained from 5 measuring spots was determined as the measurement value. The target value of the surface resistivity is LogRs (Ω/□)=8.0 to 11.0 (at 500 V), and the target value of the volume resistivity is LogRv (Ω·m)=8.0 to 11.0 (at 100 V).

### <Evaluation of Image Quality>

Each of the produced seamless belts was mounted as an intermediate transfer belt in a commercially available multi-functional printer (MFP) (Aficio SP C430DN, manufactured by Ricoh Company Limited), and a 2×2 half tone image was output. The image quality and occurrences of cracks at the belt edge during running of the belt were evaluated based on the following criteria. As for a toner, a black toner equipped in MFP was used.

### [Evaluation Criteria]

A: No unevenness, character blur (dots scattering) or white missing area was observed in the image.
B: Unevenness, character blur (dots scattering) or white missing area was slightly observed in the image.
C: Unevenness, character blur (dots scattering) or white missing area was observed in the image.

### <Evaluation of Occurrence of Crack at Belt Edge During Running of Belt>

Occurrences of crakes at the belt edge during running of the belt was visually observed and evaluated through a magnifying lens with magnification of ×4.

Note that, in Table 2, 250k means output of 250,000 sheets, 95k means output of 95,000 sheets, 65k means output of 65,000 sheets, 120k means output of 120,000 sheets, and 80k means output of 80,000 sheets.

TABLE 2

| | Product name | Ex. 1 | Ex. 2 | Ex. 3 | Ex. 4 | Ex. 5 |
|---|---|---|---|---|---|---|
| Polyether imide | ULTEM 1000(*1) | — | — | — | — | — |
| (PEI) | | | | | | |
| Silicone-modified | SILTEM SMT-1700(*2) | 80 | 80 | 80 | 80 | 80 |
| polyether imide: A | | | | | | |
| Crystalline resin: B | PPS/E1380(*3) | 20 | 20 | 20 | 20 | — |
| | PPS/T1881-3(*4) | — | — | — | — | 20 |
| | PEEK/5000G(*5) | — | — | — | — | — |
| | PVDF/KYMR741(*6) | — | — | — | — | — |
| | LCP/RB110(*7) | — | — | — | — | — |
| Compatibility | Bondfast E(*8) | 1 | 1 | 1 | 1 | 1 |
| accelerator | | | | | | |
| Electrical | DENKA BLACK(*9) | — | — | 4.5 | — | — |
| conductivity- | Ketjenblack(*10) | 4.5 | 2 | — | — | 5 |
| imparting agent | PELECTRON P(*11) | — | 3 | 3 | — | — |
| | CNT/NT-7(*12) | — | — | — | 2.5 | — |
| Mass ratio (A/B) | | 80/20 | 80/20 | 80/20 | 80/20 | 80/20 |
| Molding temperature (° C.) | | 320 | 320 | 320 | 320 | 310 |
| Molding thickness (μm) | | 72 | 73 | 75 | 78 | 90 |
| Mandrel temperature (° C.) | | 185 | 185 | 185 | 185 | 185 |
| Glass transition temperature of | | 196 | 193 | 195 | 196 | 195 |
| melt-kneaded product (° C.) | | | | | | |
| Evaluation | flame resistance | VTM-0 | VTM-0 | VTM-0 | VTM-0 | VTM-0 |
| results | tensile strength (MPa) | 65 | 65 | 66 | 67 | 59 |
| | tensile elasticity (MPa) | 2050 | 1980 | 2020 | 2005 | 2090 |
| | elongation at break (%) | 22 | 35 | 28 | 41 | 19 |
| | flexibility (MIT test value | 620 | 550 | 560 | 570 | 580 |
| | (times)) | | | | | |
| | tear strength (N/mm) | 3.1 | 3.6 | 3.8 | 3.5 | 3.1 |
| | surface resistivity, | 10.7 | 11 | 10.8 | 10.2 | 11 |
| | 100VLogRs (Ω/□) | | | | | |
| | surface resistivity, | 9.5 | 10.3 | 9.9 | 9.6 | 10.3 |
| | 500VLogRs (Ω/□) | | | | | |
| | volume resistivity, | 8.8 | 9.1 | 8.9 | 8.8 | 9.1 |
| | 100VLogRv (Ω · cm) | | | | | |
| | image quality | no | no | no | no | no |
| | | problem | problem | problem | problem | problem |
| | occurrence of crack at belt | no (250k) | no (250k) | no (250k) | no (250k) | no (250k) |
| | edge during running | | | | | |

| | Product name | Ex. 6 | Ex. 7 | Ex. 8 | Ex. 9 | Ex. 10 |
|---|---|---|---|---|---|---|
| Polyether | ULTEM 1000(*1) | — | — | — | — | — |
| imide (PEI) | | | | | | |
| Silicone- | SILTEM SMT-1700(*2) | 80 | 70 | 92 | 95 | 95 |
| modified | | | | | | |
| polyether | | | | | | |
| imide: A | | | | | | |
| Crystalline | PPS/E1380(*3) | — | — | — | 5 | 5 |
| resin: B | PPS/T1881-3(*4) | — | — | — | — | — |
| | PEEK/5000G(*5) | 20 | — | — | — | — |
| | PVDF/KYMR741(*6) | — | 30 | — | — | — |
| | LCP/RB110(*7) | — | — | 8 | — | — |
| Compatibility | Bondfast E(*8) | 1 | 2 | 2 | 1 | 1 |
| accelerator | | | | | | |
| Electrical | DENKA BLACK(*9) | — | — | — | — | — |
| conductivity- | Ketjenblack(*10) | 5 | 4.7 | 4.8 | 4.9 | 4.7 |
| imparting | PELECTRON P(*11) | — | — | — | — | — |
| agent | CNT/NT-7(*12) | — | — | — | — | — |
| Mass ratio (A/B) | | 80/20 | 70/30 | 92/8 | 95/5 | 95/5 |
| Molding temperature (° C.) | | 360 | 310 | 320 | 320 | 320 |
| Molding thickness (μm) | | 72 | 75 | 71 | 68 | 88 |
| Mandrel temperature (° C.) | | 185 | 150 | 185 | 185 | 185 |
| Glass transition temperature of melt-kneaded | | 188 | 175 | 195 | 192 | 180 |
| product (° C.) | | | | | | |
| Evaluation | flame resistance | VTM-0 | VTM-0 | VTM-0 | VTM-0 | VTM-0 |
| results | tensile strength (MPa) | 62 | 52 | 68 | 69 | 68 |
| | tensile elasticity (MPa) | 2100 | 1805 | 2150 | 2080 | 2050 |
| | elongation at break (%) | 39 | 29 | 22 | 35 | 32 |
| | flexibility (MIT test value | 720 | 880 | 950 | 550 | 560 |
| | (times)) | | | | | |
| | tear strength (N/mm) | 3.7 | 4.5 | 3.1 | 3.3 | 3.9 |
| | surface resistivity, 100VLogRs | 11 | 10.9 | 10.5 | 10.9 | 10.2 |
| | (Ω/□) | | | | | |
| | surface resistivity, 500VLogRv | 10.1 | 9.9 | 9.8 | 9.9 | 9.3 |
| | (Ω/□) | | | | | |
| | volume resistivity, 100VLogRv | 9.3 | 9 | 8.8 | 9 | 8.8 |
| | (Ω · cm) | | | | | |
| | image quality | no | no | no | no | no |
| | | problem | problem | problem | problem | problem |
| | occurrence of crack at belt | no (250k) | no (250k) | no (250k) | no (250k) | no (250k) |
| | edge during running | | | | | |

| | Product name | Ex. 11 | Ex. 12 | Ex. 13 | Ex. 14 | Ex. 15 |
|---|---|---|---|---|---|---|
| Polyether | ULTEM 1000(*1) | — | — | — | — | — |
| imide (PEI) | | | | | | |
| Silicone-modified | SILTEM SMT-1700(*2) | 90 | 70 | 30 | 20 | 5 |
| polyether imide: A | | | | | | |
| Crystalline | PPS/E1380(*3) | 10 | 30 | 70 | 80 | 95 |
| resin: B | PPS/T1881-3(*4) | — | — | — | — | — |
| | PEEK/5000G(*5) | — | — | — | — | — |
| | PVDF/KYMR741(*6) | — | — | — | — | — |
| | LCP/RB110(*7) | — | — | — | — | — |
| Compatibility | Bondfast E(*8) | 1 | 1 | 1 | 1 | 1 |
| accelerator | | | | | | |
| Electrical | DENKA BLACK(*9) | — | — | — | — | — |
| conductivity- | Ketjenblack(*10) | 4.6 | 4.3 | 4.2 | 4.3 | 4.5 |
| imparting | PELECTRON P(*11) | — | — | — | — | — |
| agent | CNT/NT-7(*12) | — | — | — | — | — |
| Mass ratio (A/B) | | 90/10 | 70/30 | 30/70 | 20/80 | 5/95 |
| Molding temperature (° C.) | | 330 | 330 | 320 | 320 | 310 |
| Molding thickness (μm) | | 70 | 72 | 75 | 85 | 86 |
| Mandrel temperature (° C.) | | 185 | 185 | 185 | 185 | 185 |
| Glass transition temperature of | | 195 | 192 | 188 | 85 | 83 |
| melt-kneaded product (° C.) | | | | | | |
| Evaluation | flame resistance | VTM-0 | VTM-0 | VTM-0 | VTM-0 | VTM-0 |
| results | tensile strength (MPa) | 61 | 62 | 58 | 56 | 55 |
| | tensile elasticity (MPa) | 1995 | 1980 | 1920 | 1820 | 1850 |
| | elongation at break (%) | 38 | 33 | 20 | 40 | 35 |
| | flexibility (MIT test value | 610 | 560 | 1010 | 2350 | 2400 |
| | (times)) | | | | | |
| | tear strength (N/mm) | 3.8 | 4.5 | 6.5 | 7.5 | 7.5 |
| | surface resistivity, | 10.9 | 10.5 | 10.9 | 10.7 | 11 |
| | 100VLogRs (Ω/□) | | | | | |
| | surface resistivity, | 10 | 9.6 | 10 | 9.8 | 10 |
| | 500VLogRv (Ω/□) | | | | | |
| | volume resistivity, | 9.2 | 8.9 | 9.1 | 8.8 | 9.2 |
| | 100VLogRv (Ω · cm) | | | | | |
| | image quality | no | no | no | no | no |
| | | problem | problem | problem | problem | problem |
| | occurrence of crack at belt | no (250k) | no (250k) | no (250k) | no (250k) | no (250k) |
| | edge during running | | | | | |
| | Product name | Ex. 16 | Ex. 17 | Ex. 18 | Ex. 19 | Ex. 20 |
| Polyether | ULTEM 1000(*1) | — | — | — | — | — |
| imide | | | | | | |
| (PEI) | | | | | | |
| Silicone-modified | SILTEM SMT-1700(*2) | 80 | 80 | 80 | 80 | 80 |
| polyether imide: A | | | | | | |
| Crystalline | PPS/E1380(*3) | 20 | 20 | 20 | 20 | 20 |
| resin: B | PPS/T1881-3(*4) | — | — | — | — | — |
| | PEEK/5000G(*5) | — | — | — | — | — |
| | PVDF/KYMR741(*6) | — | — | — | — | — |
| | LCP/RB110(*7) | — | — | — | — | — |
| Compatibility | Bondfast E(*8) | 0.3 | 0.5 | 1 | 1.5 | 2 |
| accelerator | | | | | | |
| Electrical | DENKA BLACK(*9) | — | — | — | — | — |
| conductivity- | Ketjenblack(*10) | 4.5 | 4.5 | 4.5 | 4.5 | 4.5 |
| imparting | PELECTRON P(*11) | — | — | — | — | — |
| agent | CNT/NT-7(*12) | — | — | — | — | — |
| Mass ratio (A/B) | | 80/20 | 80/20 | 80/20 | 80/20 | 80/20 |
| Molding temperature (° C.) | | 320 | 320 | 320 | 320 | 320 |
| Molding thickness (μm) | | 80 | 80 | 80 | 80 | 80 |
| Mandrel temperature (° C.) | | 185 | 185 | 185 | 185 | 185 |
| Glass transition temperature of | | 194 | 193 | 85 | 86 | 86 |
| melt-kneaded product (° C.) | | | | | | |
| Evaluation | flame resistance | VTM-0 | VTM-0 | VTM-0 | VTM-0 | VTM-0 |
| results | tensile strength (MPa) | 63 | 62 | 60 | 58 | 56 |
| | tensile elasticity (MPa) | 2050 | 2050 | 2020 | 2080 | 2030 |
| | elongation at break (%) | 36 | 35 | 36 | 32 | 31 |
| | flexibility-(MIT test value | 510 | 550 | 600 | 610 | 600 |
| | (times)) | | | | | |
| | tear strength (N/mm) | 3.8 | 3.6 | 3.8 | 3.7 | 3.6 |
| | surface resistivity, | 11 | 10.8 | 11 | 10.9 | 10.2 |
| | 100VLogRs (Ω/□) | | | | | |
| | surface resistivity, | 10.1 | 9.9 | 10 | 10 | 9.5 |
| | 500VLogRv (Ω/□) | | | | | |
| | volume resistivity, | 9.2 | 8.9 | 8.9 | 9.0 | 8.3 |
| | 100VLogRv (Ω · cm) | | | | | |
| | image quality | no | no | no | no | no |
| | | problem | problem | problem | problem | problem |
| | occurrence of crack at belt | no (250k) | no (250k) | no (250k) | no (250k) | no (250k) |
| | edge during running | | | | | |

| | Product name | Ex. 21 | Ex. 22 |
|---|---|---|---|
| Polyether imide | ULTEM 1000(*1) | — | — |
| (PEI) | | | |
| Silicone-modified | SILTEM SMT-1700(*2) | 60 | 50 |
| polyether imide: A | | | |
| Crystalline | PPS/E1380(*3) | 40 | 50 |
| resin: B | PPS/T1881-3(*4) | — | — |
| | PEEK/5000G(*5) | — | — |
| | PVDF/KYMR741(*6) | — | — |
| | LCP/RB110(*7) | — | — |
| Compatibility | Bondfast E(*8) | 1 | 1 |
| accelerator | | | |
| Electrical | DENKA BLACK(*9) | — | — |
| conductivity-imparting | Ketjenblack(*10) | 6.5 | 6.5 |
| agent | PELECTRON P(*11) | — | — |
| | CNT/NT-7(*12) | — | — |

| | | |
|---|---|---|
| Mass ratio (A/B) | 60/40 | 50/50 |
| Molding temperature (° C.) | 330 | 330 |
| Molding thickness (μm) | 81 | 81 |
| Mandrel temperature (° C.) | 185 | 185 |
| Glass transition temperature of melt-kneaded product (° C.) | 193 | 193 |

| | | | |
|---|---|---|---|
| Evaluation | flame resistance | VTM-0 | VTM-0 |
| results | tensile strength (MPa) | 63 | 59 |
| | tensile elasticity (MPa) | 1890 | 1890 |
| | elongation at break (%) | 29 | 15 |
| | flexibility(MIT test value (times)) | 532 | 520 |
| | tear strength (N/mm) | 3.7 | 3.2 |
| | surface resistivity, 100VLogRs (Ω/□) | 9.8 | 9.5 |
| | surface resistivity, 500VLogRs (Ω/□) | 8.9 | 8.6 |
| | volume resistivity, 100VLogRv (Ω/cm) | 8.8 | 8.5 |
| | image quality | no | no |
| | | problem | problem |
| | occurrence of crack at belt edge during | no | no |
| | running | problem | problem |
| | | (250k) | (250k) |

| | | Comp. | Comp. | Comp. | Comp. | Comp. |
|---|---|---|---|---|---|---|
| | Product name | Ex. 1 | Ex. 2 | Ex. 3 | Ex. 4 | Ex. 5 |
| Polyether | ULTEM 1000(*1) | 100 | 80 | 70 | 70 | 70 |
| imide (PEI) | | | | | | |
| Siliconemodified- | SILTEM SMT-1700(*2) | — | — | — | — | — |
| polyether imide: A | | | | | | |
| Crystalline | PPS/E1380(*3) | — | — | — | 30 | — |
| resin: B | PPS/T1881-3(*4) | — | 20 | — | — | — |
| | PEEK/5000G(*5) | — | — | 30 | — | — |
| | PVDF/KYMR741(*6) | — | — | — | — | 30 |
| | LCP/RB110(*7) | — | — | — | — | — |
| Compatibility | Bondfast E(*8) | — | 1 | 1 | 1 | 1 |
| accelerator | | | | | | |
| Electrical | DENKA BLACK(*9) | — | — | — | — | — |
| conductivity- | Ketjenblack(*10) | 6.5 | 5.2 | 5 | 4.5 | 6 |
| imparting | PELECTRON P(*11) | — | — | — | — | — |
| agent | CNT/NT-7(*12) | — | — | — | — | — |
| Mass ratio (A/B) | | — | — | — | — | — |
| Molding temperature (° C.) | | 350 | 330 | 360 | 340 | 320 |
| Molding thickness (μm) | | 85 | 80 | 86 | 82 | 88 |
| Mandrel temperature (° C.) | | 185 | 185 | 185 | 185 | 185 |
| Glass transition temperature of | | 215 | 211 | 212 | 212 | 209 |
| melt-kneaded product (° C.) | | | | | | |
| Evaluation | flame resistance | VTM-1 | VTM-1 | VTM-1 | VTM-1 | VTM-1 |
| results | tensile strength (MPa) | 102 | 58 | 73 | 75 | 70 |
| | tensile elasticity (MPa) | 2200 | 1850 | 1950 | 1990 | 1830 |
| | elongation at break (%) | 29 | 17 | 21 | 35 | 45 |
| | flexibility(MIT test value | 180 | 530 | 600 | 620 | 820 |
| | (times)) | | | | | |
| | Tear strength (N/mm) | 2.5 | 3.1 | 3.2 | 3.9 | 5.2 |
| | surface resistivity, | 10.5 | 10.8 | 10.8 | 11 | 11.2 |
| | 100VLogRs (Ω/□) | | | | | |
| | surface resistivity, | 10.6 | 10.2 | 10.3 | 9.8 | 10 |
| | 500VLogRs (Ω/□) | | | | | |
| | volume resistivity, | 7.8 | 7.5 | 7.0 | 8.8 | 8.5 |
| | 100VLogRv (Ω/cm) | | | | | |
| | Image quality | no | no | no | no | no |
| | | problem | problem | problem | problem | problem |
| | occurrence of crack at belt | yes (split | no (250k) | no (250k) | no (250k) | no (250k) |
| | edge during | at 95k) | | | | |
| | running | | | | | |

| | Product name | Comp. Ex. 6 | Comp. Ex. 7 | Comp. Ex. 8 |
|---|---|---|---|---|
| Polyether imide | ULTEM 1000(*1) | 90 | — | — |
| (PEI) | | | | |
| Silicone-modified | SILTEM SMT-1700(*2) | — | 80 | 100 |
| polyether imide: A | | | | |
| Crystalline resin: B | PPS/E1380(*3) | — | 20 | — |
| | PPS/T1881-3(*4) | — | — | — |
| | PEEK/5000G(*5) | — | — | — |
| | PVDF/KYMR741(*6) | — | — | — |
| | LCP/RB110(*7) | 10 | — | — |
| Compatibility | Bondfast E(*8) | 1.5 | — | — |
| accelerator | | | | |
| Electrical | DENKA BLACK(*9) | — | — | — |
| conductivity-imparting | Ketjenblack(*10) | 4.5 | 7.5 | 5.3 |
| agent | PELECTRON P(*11) | — | — | — |
| | CNT/NT-7(*12) | — | — | — |
| Mass ratio (A/B) | | 90/10 | 80/20 | 100/0 |
| Molding temperature (° C.) | | 340 | 330 | 330 |
| Molding thickness (μm) | | 85 | 75 | 87 |
| Mandrel temperature (° C.) | | 185 | 185 | 185 |
| Glass transition temperature of melt-kneaded product | | 215 | 192 | 198 |
| (° C.) | | | | |
| Evaluation | flame resistance | VTM-1 | VTM-0 | VTM-0 |
| results | tensile strength (MPa) | 102 | 62 | 65 |
| | tensile elasticity (MPa) | 2150 | 1850 | 1980 |
| | elongation at break (%) | 15 | 25 | 25 |
| | flexibility(MIT test value (times)) | 195 | 320 | 260 |
| | tear strength (N/mm) | 2.8 | 3.5 | 3.5 |
| | surface resistivity, 100VLogRs (Ω/□) | 11.1 | 7.5 | 10.5 |
| | surface resistivity, 500VLogRs (Ω/□) | 10 | 5.1 | 9.5 |
| | volume resistivity, 100VLogRv | 8.9 | 4.5 | 8.6 |
| | (Ω · cm) | | | |
| | image quality | no | problem | no |
| | | problem | (white | problem |
| | | | missing | |
| | | | area) | |
| | occurrence of crack at belt edge | yes (65k) | yes (120k) | yes (80k) |
| | during running | | | |

The details of the product names in Table 2 are as follows:

(*1) Polyether imide (PEI): ULTEM 1000, manufactured by SABIC Innovative Plastics Japan
(*2) Polyether imide containing a siloxane bond(silicone-modified polyether imide): SILTEM SMT-1700, manufactured by SABIC Innovative Plastics Japan
(*3) Crystalline resin: polyphenylene sulfide (PPS) (E1380, linear PPS, manufactured by Toray Industries Inc.)
(*4) Crystalline resin: polyphenylene sulfide (PPS) (T1881-3, linear high molecular PPS, manufactured by Toray Industries Inc.)
(*5) Crystalline resin: polyether ether ketone (PEEK) (5000G, manufactured by Daicel-Evonik Ltd.)
(*6) Crystalline resin: polyvinylidene fluoride (PVDF) (KYMR741, manufactured by Arkema K.K.)
(*7) Crystalline resin: liquid crystal polymer (LCP) RB110, manufactured by Sumitomo Chemical Co., Ltd.)
(*8) Compatibility accelerator: ethylene-glycidyl methacrylate copolymer, is Bondfast E, manufactured by Sumitomo Chemical Co., Ltd.
(*9) Electrical conductivity-imparting agent: DENKA BLACK, manufactured by DENKI KAGAKU KOGYO KABUSHIKI KAISHA
(*10) Electrical conductivity-imparting agent: Ketjenblack EC300J, manufactured by Lion Corporation
(*11) Electrical conductivity-imparting agent: high molecular antistatic agent (PELECTRON P, manufactured by Sanyo Chemical Industries, Ltd.)
(*12) Electrical conductivity-imparting agent: carbon nanotubes (CNT) (NT-7, manufactured by Hodogaya Chemical Co., Ltd.)

The embodiments of the present invention are, for example, as follows:

<1> A seamless belt, containing:

a polyether imide containing a siloxane bond;

at least one selected from the group consisting of a polyphenylene sulfide, a polyether ether ketone, a thermoplastic fluororesin, and a liquid crystal polymer;

an ethylene-glycidyl (meth)acrylate copolymer; and

an electrical conductivity-imparting agent.

The seamless belt as specified in <1> can exhibit the following excellent effects: (1) flame resistance of the seamless belt improves as the polyether imide containing a siloxane bond is blended therein, and VTM-0 of the UL944 standard can be achieved; (2) mechanical characteristics (elongation, MIT test value, etc.) of the film are improved owing to a synergistic effect of the polymer alloy composed of the polyether imide containing a siloxane bond, and at least one selected from the group consisting of the polyphenylene sulfide, the polyether ether ketone, the thermoplastic fluororesin, and the liquid crystal polymer; (3) a film thickness thereof can be uniformly controlled; (4) electrical characteristics thereof can be controlled, and surface resistivity and volume resistivity of high accuracy and high stability with repetitive use can be attained; (5) high durability, i.e. continuous feeding of 200,000 sheets or more in an image forming apparatus, can be attained, as the belt of high elasticity is obtained.

<2> The seamless belt according to <1>, wherein a mass ratio (A/B) of the polyether imide containing a siloxane bond (A) to the at least one selected from the group consisting of a polyphenylene sulfide, a polyether ether ketone, a thermoplastic fluororesin, and a liquid crystal polymer (B) is in the range of 90/10 to 70/30, or in the range of 10/90 to 30/70.

The seamless belt as specified in <2> can attain desirable mechanical characteristics with varying the mass ratio (A/B) to the range of 90/10 to 70/30, or the range of 10/90 to 30/70. In the case where a film of high tensile strength or high elasticity is required, for example, such film can be attained by using the liquid crystal polymer (LCP).

<3> The seamless belt according to any of <1> or <2>, wherein an amount of the ethylene-glycidyl (meth)acrylate copolymer is 0.5% by mass to 5% by mass.
<4> The seamless belt according to any one of <1> to <3>, wherein the electrical conductivity-imparting agent is carbon black.

The seamless belt as specified in <4> can provide an electrically conductive resin belt at low cost, as inexpensive electrically conductive carbon black is used. Moreover, the electric resistance that has less environmental dependency and is stable can be attained.

<5> The seamless belt according to any one of <1> to <3>, wherein the electrical conductivity-imparting agent is a combination of carbon black and a polymeric electrically conductive agent.

The seamless belt as specified in <5> exhibits the following excellent effects: (1) an amount of the electrically conductive carbon black is reduced by using the electrically conductive carbon black and the polymeric electrically conductive agent in combination, which can prevent deterioration of mechanical characteristics, and therefore cracking or splitting of an edge of the belt during running of the belt can be prevented; (2) electrical characteristics thereof can be controlled, and surface resistivity and volume resistivity of high accuracy and high stability with repetitive use can be attained; and (3) the electric resistance that has less environmental dependency and is stable can be attained.

<6> The seamless belt according to any one of <1> to <3>, wherein the electrical conductivity-imparting agent is carbon nanotubes.

The seamless belt as specified in <6> exhibits the following excellent effects: (1) desirable electric resistance is attained with the carbon nanotubes in an amount of 5% by mass or less, which prevents deterioration of mechanical characteristics, and therefore cracking or splitting of an edge of the belt during running of the belt can be prevented; and (2) the electric resistance that has less environmental dependency and is stable can be attained.

<7> A method for producing a seamless belt, containing:

melt-kneading a polyether imide containing a siloxane bond, an ethylene-glycidyl (meth)acrylate copolymer, an electrical conductivity-imparting agent, and at least one selected from the group consisting of a polyphenylene sulfide, a polyether ether ketone, a thermoplastic fluororesin, and a liquid crystal polymer, to thereby obtain a melt-kneaded product; and

extrusion-molding the melt-kneaded product.

The method for producing a seamless belt, as specified in <7>, can exhibits the following excellent effects: (1) an inexpensive seamless belt can be provided by an inexpensive production process of an electrically conductive resin belt; (2) a belt having stable quality can be produced by controlling resistance, viscoelasticity, and mechanical characteristics of the melt-kneaded product, followed by molding the belt.

<8> The method according to <7>, wherein the extrusion-molding contains providing a mandrel at a bottom of a circular die with respect to an extruding direction where the mandrel is linked with the circular die, and cooling the extrusion-molded product extruded from the circular die by the mandrel to temperature equal to or lower than glass transition temperature of the melt-kneaded product.

The method for producing a seamless belt, as spec fled in <8>, exhibits the following effects; (1) a belt with a stable size (peripheral length) can be produced; (2) the belt with stable mechanical strength and quality can be produced; (3) glossiness of the belt can be controlled, and the seamless belt having excellent surface gloss can be produced; and (4) the seamless belt having uniform electric resistance can be produced.

<9> An image forming apparatus, containing:

an image bearing member;

an electrostatic latent image forming unit configured to form an so electrostatic latent image on the image bearing member;

a developing unit configured to develop the electrostatic latent image formed on the image bearing member with a toner, to form a toner image;

a primary transferring unit configured to transfer the toner image on the image bearing member onto an intermediate transfer belt;

a secondary transferring unit configured to transfer the toner image on the intermediate transfer belt onto a recording medium;

a fixing unit configured to fix the toner image on the recording medium,

wherein the intermediate transfer belt is the seamless belt according to any one of <1> to <6>.

<10> An image forming apparatus, containing;

an image bearing member;

an electrostatic latent image forming unit configured to form an electrostatic latent image on the image bearing member;

a developing unit configured to develop the electrostatic latent image formed on the image bearing member with a toner, to form a toner image;

a transfer belt configured to convey a recording medium, onto which the toner image on the image bearing member is transferred;

a transferring unit configured to transfer the toner image on the image bearing member onto the recording medium; and

a fixing unit configured to fix the toner image on the recording medium,

therein the transfer belt is the seamless belt according to any one of <1> to <6>.

This application claims priority to Japanese application No. 2012-287413, filed on Dec. 28, 2012 and incorporated herein by reference.

What is claimed is:

1. A seamless belt, comprising:
a polyether imide containing a siloxane bond;
at least one selected from the group consisting of a polyphenylene sulfide, a polyether ether ketone, a thermoplastic fluororesin, and a liquid crystal polymer;
an ethylene-glycidyl (meth)acrylate copolymer; and
an electrical conductivity-imparting agent.

2. The seamless belt according to claim 1, wherein a mass ratio (A/B) of the polyether imide containing a siloxane bond (A) to the at least one selected from the group consisting of a polvphenylene sulfide, a polyether ether ketone, a thermoplastic fluororesin, and a liquid crystal polymer (B) is in the range of 90/10 to 70/30, or in the range of 10/90 to 30/70.

3. The seamless belt according to claim 1, wherein an amount of the ethylene-glycidyl (meth)acrylate copolymer is 0.5% by mass to 5% by mass.

4. The seamless belt according to claim 1, wherein the electrical conductivity-imparting agent is carbon black.

5. The seamless belt according to claim 1, wherein the electrical conductivity-imparting agent is a combination of carbon black and a polymeric electrically conductive agent.

6. The seamless belt according to claim 1, wherein the electrical conductivity-imparting agent is carbon nanotubes.

7. A method for producing a seamless belt, comprising:
melt-kneading a polyether imide containing a siloxane bond, an ethylene-glycidyl (meth)acrylate copolymer, an electrical conductivity-imparting agent, and at least one selected from the group consisting of a polyphenylene sulfide, a polyether ether ketone, a thermoplastic fluororesin, and a liquid crystal polymer, to thereby obtain a melt-kneaded product; and
extrusion-molding the melt-kneaded product.

8. The method according to claim 7, wherein the extrusion-molding contains providing a mandrel at a bottom of a circular die with respect to an extruding direction where the mandrel is linked with the circular die, and cooling the extrusion-molded product extruded from the circular die by the mandrel to temperature equal to or lower than glass transition temperature of the melt-kneaded product.

9. An image forming apparatus, comprising:
an image bearing member;
an electrostatic latent image forming unit configured to form an electrostatic latent image on the image bearing member;
a developing unit configured to develop the electrostatic latent image formed on the image bearing member with a toner, to form a toner mage;
a transfer belt configured to convey a recording medium, onto which the toner image on the image bearing member is transferred;
a transferring unit configured to transfer the toner image on the image bearing member onto the recording medium; and
a fixing unit configured to fix the toner image on the recording medium,
wherein the transfer belt is a seamless belt, which comprises:
a polyether imide containing a siloxane bond;
at least one selected from the group consisting of a polyphenylene sulfide, a polyether ether ketone, a thermoplastic fluororesin, and a liquid crystal polymer;
an ethylene-glycidyl (meth)acrylate copolymer; and
an electrical conductivity-imparting agent.

10. The image forming apparatus according to claim 9, wherein the transferring unit contains: a primary transferring unit configured to transfer the toner image on the image bearing member onto an intermediate transfer belt; and a secondary transferring unit configured to transfer the toner image on the intermediate transfer belt onto the recording medium.
